(19) United States
(12) Patent Application Publication
(10) Pub. No.: US 2014/0355703 A1
(43) Pub. Date: Dec. 4, 2014

(54) Codeword Structure For Multi-Structured Codebooks

(71) Applicant: Broadcom Corporation, Irvine, CA (US)

(72) Inventors: Karol SCHOBER, Helsinki (FI); Tommi KOIVISTO, Espoo (FI); Mihai ENESCU, Espoo (FI)

(73) Assignee: Broadcom Corporation, Irvine, CA (US)

(21) Appl. No.: 13/908,598

(22) Filed: Jun. 3, 2013

(51) Int. Cl. H04B 7/04

(52) U.S. Cl. CPC H04B 7/0417; H04B 7/0486
USPC 375/267

(57) ABSTRACT

A multi-structured codebook includes a wideband codebook portion C(W₁) and a frequency-selective codebook portion C(W₂). The wideband portion C(W₁) is characterized by a shifted set of indices for at least rank 1 such that the set of indices centers different groups of neighboring beams around a center beam in front of an antenna array. In one example, for rank 1 the indices run 24, 25, . . . 31, 0, 1, . . . 7. The frequency-selective portion C(W₂) is characterized by having a non-equal number of entries for beams in a corresponding W₁ codeword from the wideband codebook portion C(W₁). In the examples some W₁ codewords have corresponding W₂ codewords with multiple same-beams and one or more different beams per polarization. A codeword W₂ is selected from the frequency-selective codebook portion C(W₂) and another codeword W₁ is selected from the wideband codebook portion C(W₁) for signaling channel conditions.

### CROSS REFERENCE TO RELATED APPLICATIONS

This application is related to UK patent application no. GB 130408.2, filed on 7 Mar. 2013, the entire contents of which are hereby incorporated by reference.

### TECHNICAL FIELD

The exemplary and non-limiting embodiments of this invention relate generally to wireless communication systems, methods, devices and computer programs and, more specifically, relate to codebooks used for wireless multi-path communications such as multi-input/multi-output (MIMO) and cooperative multipoint (CoMP) communications.

### BACKGROUND

Multi-path communications are known in the wireless arts and are used to boost spectral efficiency. For example, the Third Generation Partnership Project (3GPP) Evolved Universal Terrestrial Radio Access system (E-UTRA, alternatively known as long term evolution of UTRA or LTE) supports both single-user (SU-) and multi-user (MU-) MIMO schemes. The performance of these MIMO schemes is highly dependent on the quality of channel state information (CSI) feedback obtained from the user equipment (UE). In LTE this CSI feedback comprises a precoding matrix indication (PMI), a channel quality indication (CQI) and a rank indication (RI). The PMIs are selected by the UE from a known codebook; one that is known in advance to both the network access node (eNB) and the UE. The codebook is typically specified in a published wireless protocol, and where there is a choice of codebooks the operative one can be made known to the UE via signaling. These codebooks have generally remained the same throughout earlier development of LTE: the codebooks for two and four transmit antennas have been specified already in Release 8 and the codebook for eight transmit antennas was specified in Release 10.

As part of development towards the Release 12 LTE specification, 3GPP is studying further enhancements to CSI feedback, in particular targeting deployments with four transmit antennas at the transmitter side. Specifically, it was agreed in the Radio Access Network Working Group 1 (RAN WG1) meeting #73 to select the Release 12 codebook from two proposals 2a and 2b that are set forth in document R1-132738 entitled Way Forward of 4Tx Rank 1 and 2 Codebook Design for Downlink MIMO Enhancement in Rel-12 (3GPP TSG RAN WGC #73; Fukuoka, Japan; 20-24 May 2013]. Document R1-132738 is hereby incorporated by reference. Both of these proposals concern a dual codebook (DCB), sometimes referred to as a double structured codebook. DCBs are known in the art and in fact are standardized already in 3GPP Release 10 for 8-Tx antennas: see section 7.2.4 of 3GPP TS 36.213 v11.1.0 (2012-02). DCBs are characterized in having a wideband codebook portion C(W₁) and a frequency-selective codebook portion C(W₂).

Both proposed DCBs in document R1-132738 utilize the same wide-band/long-term part C(W₁) and rank 1 sub-band/short-term part C(W₂) design; these two proposals differ only in the design of the rank-2 sub-band/short-term part C(W₂). While evaluating these two proposed dual codebooks the inventors have found they are sub-optimal. These teachings provide an improved dual codebook.

Dual codebooks are useful in radio communications, particularly wireless multi-path (multi-beam) communications such as MIMO and CoMP communications and hybrids thereof in which the individual wireless messages are transmitted and received across different beams. Optimized codebooks provide for improved CSI accuracy, which as noted above leads to improved throughput in communication systems using MIMO, CoMP and/or other types of multi-path transmission (Tx) and reception (Rx) techniques.

### SUMMARY

In a first exemplary aspect of the invention there is a method for controlling a wireless radio device to provide feedback about channel conditions. In this aspect the method comprises: storing in a computer readable memory of the wireless radio device a multi-structured codebook comprising a wideband codebook portion C(W₁) and a frequency-selective codebook portion C(W₂), wherein the wideband codebook portion C(W₁) is characterized by a shifted set of indices for at least rank 1 such that the set of indices centers different groups of neighboring beams around a center beam in front of an antenna array, and wherein the frequency-selective codebook portion C(W₂) is characterized by having a non-equal number of entries for beams in a corresponding W₁ codeword from the wideband codebook portion C(W₁). In this aspect the method further comprises constructing a precoder W from a codeword W₂, selected from the frequency-selective codebook portion C(W₂) and from another codeword W₁ selected from the wideband codebook portion C(W₁) for signaling channel conditions.

In a second exemplary aspect of the invention there is an apparatus for controlling a wireless radio device to provide feedback about channel conditions. In this aspect the apparatus comprises a processing system, and the processing system comprises at least one processor and a memory storing a set of computer instructions. Stored in the memory of the wireless radio device is a multi-structured codebook comprising a wideband codebook portion C(W₁) and a frequency-selective codebook portion C(W₂), wherein the wideband codebook portion C(W₁) is characterized by a shifted set of indices for at least rank 1 such that the set of indices centers different groups of neighboring beams around a center beam in front of an antenna array, and wherein the frequency-selective codebook portion C(W₂) is characterized by having a non-equal number of entries for beams in a corresponding W₁ codeword from the wideband codebook portion C(W₁). In this aspect the processing system further causes the apparatus to construct a precoder W from a codeword W₂ selected from the frequency-selective codebook portion C(W₂) and from another codeword W₁ selected from the wideband codebook portion C(W₁) for signaling channel conditions.

In a third exemplary aspect of the invention there is a computer readable memory tangibly storing a set of computer executable instructions for controlling a wireless radio device to provide feedback about channel conditions. In this aspect the set of computer executable instructions comprises: code for storing in a computer readable memory of the wireless radio device a multi-structured codebook comprising a wideband codebook portion C(W₁) and a frequency-selective codebook portion C(W₂), wherein the wideband codebook portion C(W₁) is characterized by a shifted set of indices for at least rank 1 such that the set of indices centers different groups of neighboring beams around a center beam in front of an antenna array, and wherein the frequency-selective codebook portion C(W₂) is characterized by having a non-equal number of entries for beams in a corresponding W₁ codeword from the wideband codebook portion C(W₁). The computer executable instructions further comprises code for constructing a precoder W from a codeword W₂ selected from the frequency-selective codebook portion C(W₂) and from another codeword W₁ selected from the wideband codebook portion C(W₁) for signaling channel conditions.

These and other aspects are detailed below with more particularity.

### BRIEF DESCRIPTION OF THE DRAWINGS

FIG. 1 is a prior art dual codebook reproduced from Solution 2a set forth in document R1-132738.

FIG. 2 is a table listing the presence of beam indexes in W₁ codewords n=0, 1 . . . 15 for the codebook according to FIG. 1.

FIG. 3 is a plot of selection statistics from a system-level simulator for the W₁ codewords according to FIG. 1, and shows selection likelihood along the vertical axis for a given W₁ codeword along the horizontal axis.

FIG. 4 is a table showing shifted W1 codeword indices for three beams in W1 according to an example embodiment of these teachings.

FIG. 5 repeats the W1 codeword indices from FIG. 2 for the same three beams in W1 as are shown for FIG. 4, for ease in comparing these two indexing arrangements.

FIGS. 6A-C and 7A-C show antenna gain for different combinations of antenna spacing and timing advance error to compare a solution according to these teachings against the codebook of FIG. 1 as well as the codebook from LTE Release-8.

FIG. 8 is a logic flow diagram that illustrates a method for operating a wireless radio device, such as for example a user equipment/UE or a network access device, and a result of execution by an apparatus of a set of computer program instructions embodied on a computer readable memory for operating such a device, in accordance with certain exemplary embodiments of this invention

FIG. 9 is a simplified block diagram of a UE and a wireless radio network represented by an eNodeB (eNB) and by a serving gateway, which are exemplary electronic wireless radio devices suitable for use in practicing the exemplary embodiments of the invention.

### DETAILED DESCRIPTION

The examples below are in the context of the E-UTRA system, including future releases such as what is now being contemplated as LTE-Advanced (LIE-A), but these radio access technology contexts are not limiting to the broader teachings herein. In other deployments these teachings for reporting channel conditions may be utilized with other types of radio access technologies (RATs) as may be developed for 4-Tx MIMO/CoMP, including but not limited to Wideband Code Division Multiple Access (WCDMA) and other wireless radio technologies now established or yet to be developed.

These teachings are best appreciated in comparison to current practices for codeword structure and selection. As noted above, the more comprehensive CSI feedback comprises PMI, CQI and RI. Conventional LTE allows wideband or per sub-band reporting of CQI and PMI, where one reporting sub-band consists of some integer number of physical resource blocks (PRBs) where the number of the PRBs depends on the system bandwidth and the UE's feedback mode. For example, assuming a 10 MHz bandwidth and feedback modes other than mode 2-2, the sub-band size is 6 PRBs and the RI is always reported wideband.

3GPP TS 36.213 mentioned in the background section defines different feedback modes as combinations of wideband and sub-band reporting of CQI and PMI. For example, feedback mode 3-1 means wideband PMI reporting and sub-band CQI reporting; feedback mode 2-2 means PMI and CQI are reported for the best M sub-bands which are selected by the LIE. Conventional LTE defines a further feedback mode 1-2 with sub-band PMI and wideband CQI.

In general, a double structured codebook has both a wideband component (W₁) which is long term and a frequency-selective (sub-band) component (W₂) which is short term, so a double structured 4-Tx codebook W can be defined as W=W₁W₂, where

$${W}_{1} = [ \begin{matrix}{X}_{n} & 0 \\ 0 & {X}_{n}\end{matrix} ]$$

$${X}_{n} = [ \begin{matrix}1 & 1 & 1 & 1 \\ {q}_{1}^{n} & {q}_{1}^{n + 1 t} & {q}_{1}^{n + 2 t} & {q}_{1}^{n + ( M - 1 ) t}\end{matrix} ]$$

The term

$${q}_{1} = {e}^{\frac{i2π}{L}}$$

represent beam quantization step, which allows to create L base vectors and M represents the number of neighboring base beams indexed by m. Each of these columns in X, represents a beam when applied as an antenna weight on an antenna array or sub-array. A given sub-array may for example correspond to antennas having the same polarization, or to a sub-group of antennas of a uniform linear array of antennas. Index n determines an index of the W₁ codeword. Index t denotes separation between neighboring beams.

It is not unusual for wideband portion of the codebook C(W₁) to be the same for both rank-1 and rank-2. This structure stems from the existing 8-Tx double codebook that has been specified in Release 10 at TS 36.213 v11.1.1.

For the frequency-selective portion of the codebook C(W₂) there are several indices i, j, k and l, depending on the rank index where i, k and l are each ε{1 . . . M} in which M is the total number of neighboring base beams that are included in the corresponding W₁ codeword. Indices i, k and l represent different layers such that there is one layer for RI=1, two layers for RI=2, three layers for RI=3, and so forth. The UE uses different beam selection vectors sⱼ, sₖ and sₗ to select a given codeword from the frequency-selective portion of the codebook C(W₂) for a given rank.

In rank-1, according to conventional practice the frequency-selective W₂ codewords are formed as:

$${W}_{2}^{i , j} = [ \begin{matrix}{e}_{i} \\ {exp}^{i {θ}_{j}} {e}_{i}\end{matrix} ] ,$$

where iε{1 . . . M} as above; eᵢ is the beam selection vector for the RI=1 layer which has all zeros and one at the i-th position; t is the imaginary unit; and θⱼ is an arbitrarily chosen cross-polarization co-phasing term, for example from the M-PSK alphabet. So conventionally the UE selects the W₂ codeword for RI=1 using one beam selection vector and a co-phasing term.

In rank-2, according to conventional practice (Table 7.2.4-2 of TS36.213) the frequency-selective W₂ codewords are formed as:

$${W}_{2}^{i , k , j} = [ \begin{matrix}{e}_{i} & {e}_{k} \\ {exp}^{i {θ}_{j}} {e}_{i} & - {exp}^{{iθ}_{j}} {e}_{k}\end{matrix} ] ,$$

where iε{1 . . . M} and kε{1 . . . M} as above. Conventionally the UE selects the W₂ codeword for RI=2 using two beam selection vectors and a co-phasing term. More generally, the UE uses one beam selection vector per layer and a co-phasing term for its selection of the W₂ codeword. It is important to recognize that when i=k, the term e^{tθ}^{ⱼ} does not generate a new codeword but provides only orthogonalization of the codeword. This orthogonality is particularly beneficial for linear receivers because non-linear receivers can better cope with non-orthogonality among codewords.

In general, the conventional (3GPP TS 36.213) rank-2 structure above allows for only a limited number of codewords that are optimized for cross-polarized antenna arrays, and so the rank-2 performance of this structure is not providing full flexibility for cross-polarized antenna setups. Specifically, for the case of 8-Tx codebooks half of the rank-2 codewords (i=k) are fitting better co-polarized antenna setups (uniform linear array, ULA). However, cross-polarized antennas are typically considered more relevant for practical deployments.

Now consider the dual codebook proposals set forth in document R1-132738 which is referenced in the background section above. The inventors' analysis of these has found them to be sub-optimal due to their use of wide-spaced beams in the W₁ part, which results in some ambiguity of the W1 codewords. These teachings resolve that ambiguity issue and provide a double codebook structure for 4Tx antennas. Certain particular embodiments provide for novel rank-1 W₁ and W₂ codewords that are included in a double codebook.

It has been agreed in the RAN1#73 3GPP meeting (mentioned in the background section above) that the wide-beams in the W₁ codebook part are to cover the whole beam space. Namely, a total of thirty two (32) base beams are used and four beams with wide (eight beam) separation between neighboring beams are used in one codeword of the W₁ codebook portion. In this case, the outer beams in each W₁ codeword are also neighboring beams. The codebook of proposal 2a set forth in document RI-132738 is reproduced at FIG. 1.

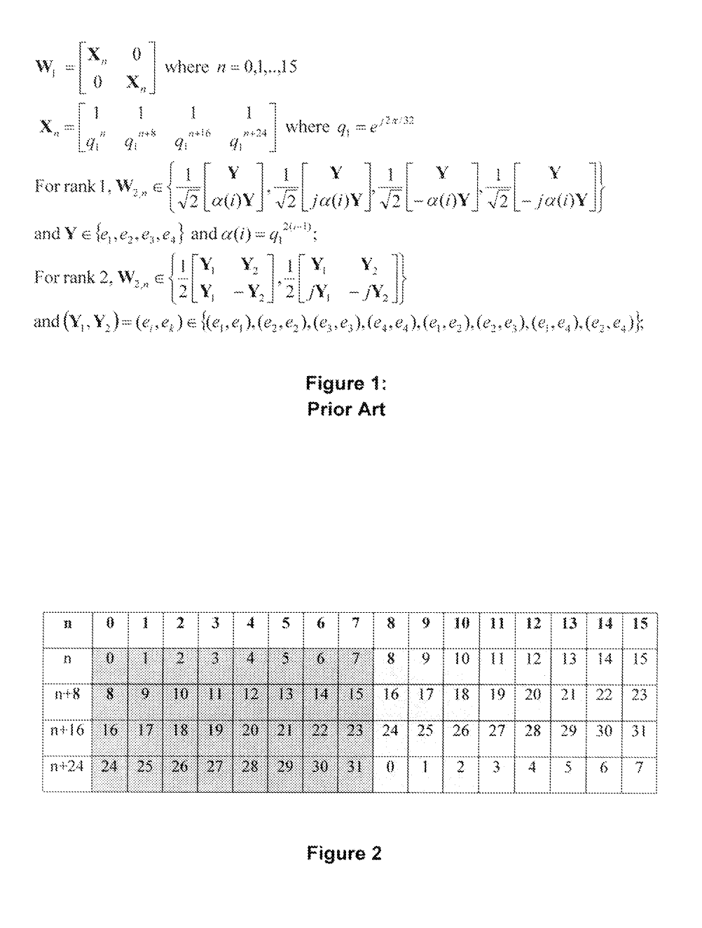

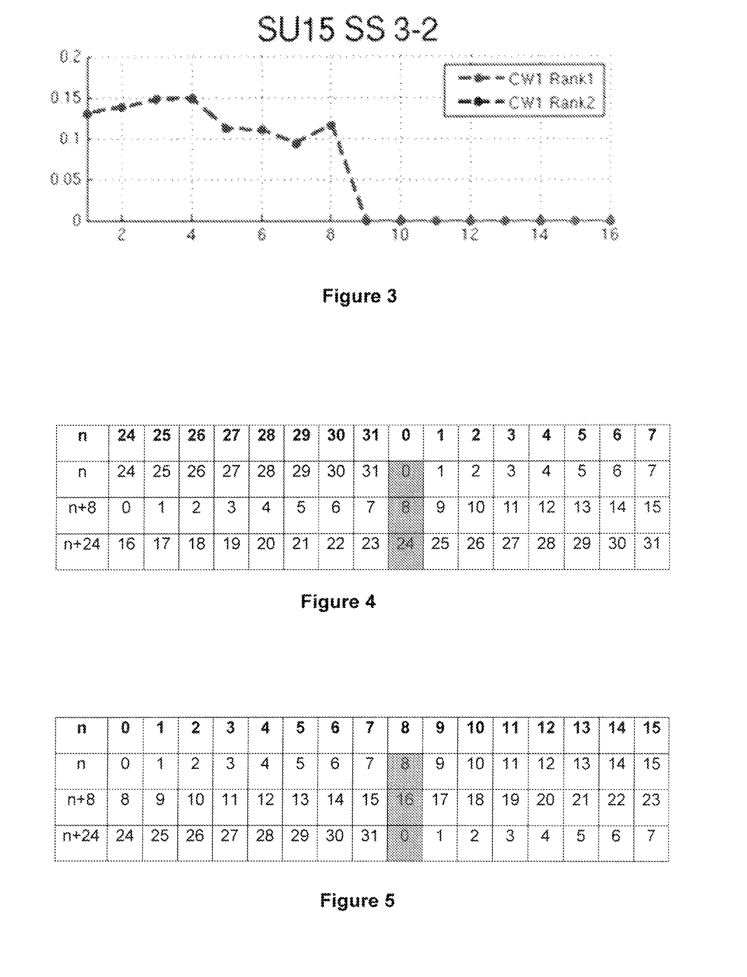

The table at FIG. 2 lists the presence of beam indexes in W₁ codewords n=0, 1 . . . 15 for the codebook according to FIG. 1. It is evident that the lighter shaded table entries under the columns for n=8, 9 . . . 15 are permutations of the darker shaded table entries under the columns for n=0, 1 . . . 7. It is suggested that as a consequence of this specific permutation codewords 8-15 are useless. Evidence supporting this suggestion is shown at FIG. 3, which is a plot of selection statistics from a system-level simulator showing the selection likelihood along the vertical axis for a given W₁ codeword along the horizontal axis. FIG. 3 makes clear that the lack of utilization of half of the codewords is total, and hence they are useless. The immediate consequence is that such a design is 3 bit (2³=8 usable codewords) and is sub-optimal as compared to 4-bit solutions (2⁴=16 usable codewords, since there are 16 unique index values for n).

One solution to this problem, consistent with the non-limiting examples set forth herein, is to avoid wide-spaced beams. However wide-spaced beams are particularly important for good rank-2 performance in wide-antenna spacing or in the presence of timing advance errors (TAE).

The inventors' analysis has revealed that the FIG. 1 codebook is a symmetric rank-1 W₂ codebook. Symmetric means that all four beams in a given W₁ codeword have the same number of entries in the W₂ codebook portion. Avoiding beams spreading over the whole beam space addresses this issue, and so codebooks implemented according to these teachings are asymmetric meaning for at least one rank there is a non-equal number of entries in the W₂ codebook for beams in any given W₁ codeword. In the examples below the non-equal number extends to all ranks.

Designing a rank-1 W₂ codebook to be asymmetric resolves the issue with ambiguity of W₁ codewords due to codewords permutation. Asymmetric means that one beam at least in any W₁ codeword has a different number of entries in the W₂ codebook portion, as will be detailed below by example.

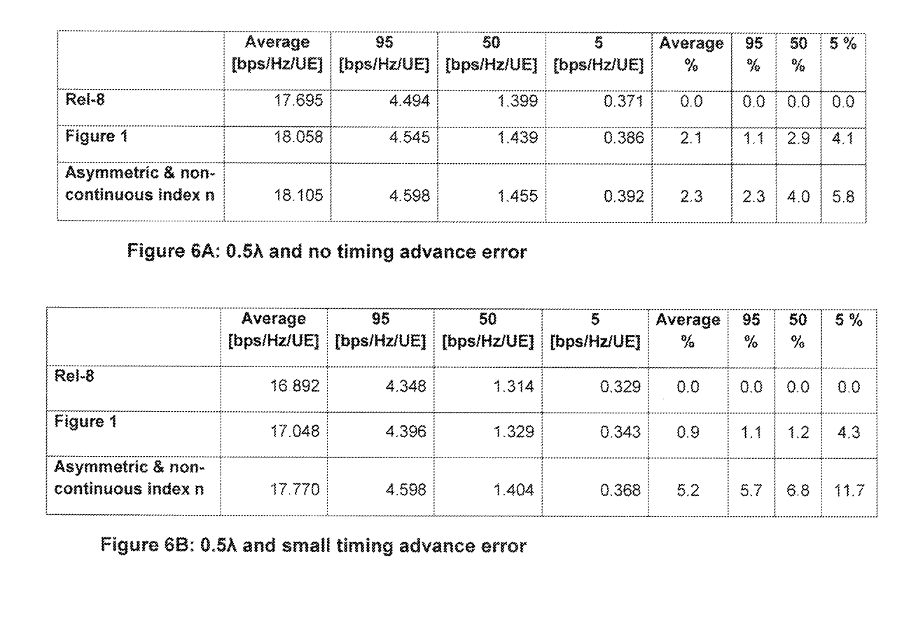

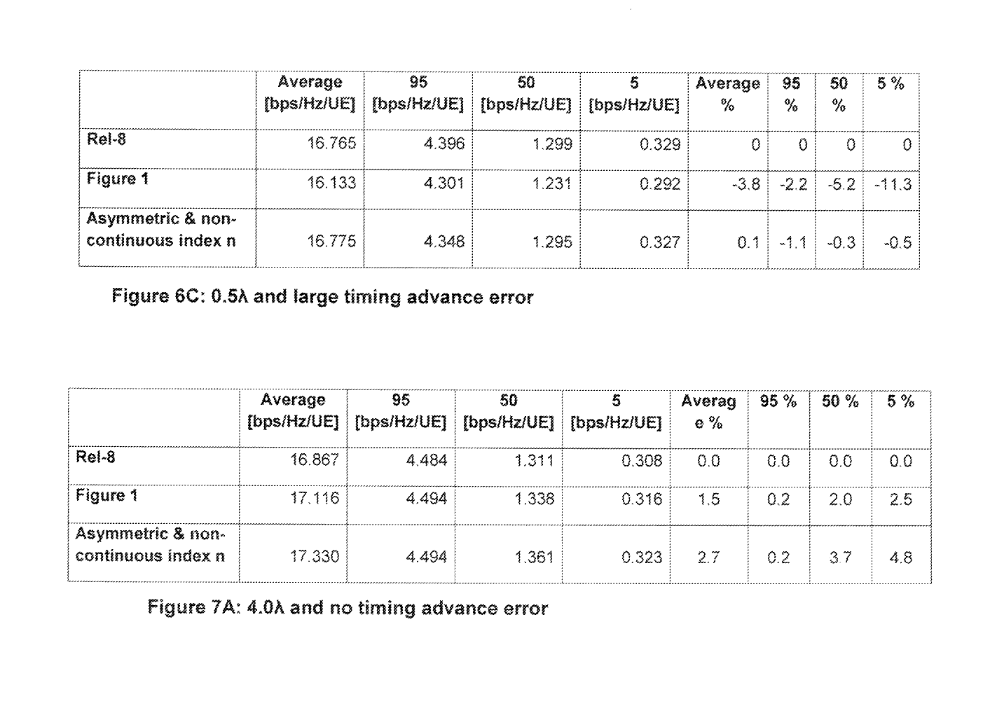

In the FIG. 1 codebook the codeword index runs n=0, 1 . . . 15. Continuing with this same size example for an asymmetric codebook, additionally the index n for the 16 codewords is not continuous. One example of such shifted indices for the codewords is shown at FIG. 4, where the indices of the sequential rank-1 codewords is n=24, 25 . . . 31, 0, 1 . . . 7. This shifted indexing for n across each different codeword rank guarantees that different sets of three neighboring beams are centered around the zero beam direction, which corresponds to transmission in front of the antenna array. The FIG. 4 arrangement shows the benefit of using shifted indices n for same-rank codewords. Note also that FIG. 4 uses only three out of four beams and the shifted indices n=24, 25 . . . 31, 0, 1 . . . 7 in the W₁ codeword.

FIG. 5 repeats the same indexing of codewords as does FIG. 2, but for only the three codeword ranks shown for FIG. 4. This is for convenience in comparing the indexing of FIG. 4. FIG. 4 shows that the codewords in FIG. 4 are unique for all the indices n. Comparing these two figures. FIG. 5 has n=0 . . . 15 for rank 1 and groups of 3 neighboring beams are centered around the beam 8, while in FIG. 4 the groups of three beams are around center beam 0. The center codewords are denoted with shading in FIGS. 4 and 5.

The three beam example embodiment with the indexing shown at FIG. 4 is characterized in the following four aspects:
It targets the energy into half of the space (2 Tx beams per polarization) and is centered around the center beam.
It solves an ambiguity problem with prior art W₁ codewords that is demonstrated at FIG. 2.
It requires only 12 codeword entries (assuming a QPSK inter-polarization combiner) in the W₂ codebook portion. The extra 4 codewords in the W₂ codebook portion may be used to increase phase quantization between polarizations, and/or to introduce codewords with a different beam per polarization. These are particularly important for robustness to timing advance errors.
It keeps the same W₁ codebook portion for both rank-1 and rank-2

The inventors have implemented and tested the prior art codebook shown at FIG. 1, as modified by these teachings to be asymmetric in W2 and also to have non-sequential indices, in a system level simulator with a Finite buffer 10 Mbit traffic model. The improved codebook as tested may be expressed as follows:

$${W}_{1} = [ \begin{matrix}{X}_{n} & 0 \\ 0 & {X}_{n}\end{matrix} ]$$

$$where n = 24 , 25 , … , 31 , 0 , 1 , … , 7$$

$${X}_{n} = [ \begin{matrix}1 & 1 & 1 & 1 \\ {q}_{1}^{n} & {q}_{1}^{n + 8} & {q}_{1}^{n + 16} & {q}_{1}^{n + 24}\end{matrix} ]$$

$$where {q}_{1} = {e}^{j 2 s / 32}$$

$$For rank 1 , \\ {W}_{2 , n} ∈ \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \} Y ∈ \{ {e}_{4} , {e}_{1} , {e}_{2} \}$$

$$\frac{1}{\sqrt{2}} [ \begin{matrix}{Y}_{1} \\ - j {Y}_{2}\end{matrix} ] ( {Y}_{1} , {Y}_{2} ) ∈ \{ ( {e}_{1} , {e}_{4} ) , ( {e}_{1} , {e}_{2} ) \} and$$

$$\frac{1}{\sqrt{2}} [ \begin{matrix}{Y}_{1} \\ - j {Y}_{2}\end{matrix} ] , ( {Y}_{1} , {Y}_{2} ) ∈ \{ ( {e}_{4} , {e}_{1} ) , ( {e}_{2} , {e}_{1} ) \}$$

$$For rank 2 , \\ {W}_{2 , n} ∈ \{ \frac{1}{2} [ \begin{matrix}{Y}_{1} & {Y}_{2} \\ {Y}_{1} & {Y}_{2}\end{matrix} ] , \frac{1}{2} [ \begin{matrix}{Y}_{1} & {Y}_{2} \\ {Y}_{1} & - {Y}_{2}\end{matrix} ] , \frac{1}{2} [ \begin{matrix}{Y}_{1} & {Y}_{2} \\ - {Y}_{1} & {Y}_{2}\end{matrix} ] , \frac{1}{2} [ \begin{matrix}{Y}_{1} & {Y}_{2} \\ - {Y}_{1} & - {Y}_{2}\end{matrix} ] \} , \\ ( {Y}_{1} , {Y}_{2} ) ∈ \{ ( {e}_{2} , {e}_{4} ) \} and$$

$${W}_{2 , n} ∈ \{ \frac{1}{2} [ \begin{matrix}{Y}_{1} & {Y}_{1} \\ {Y}_{1} & - {Y}_{1}\end{matrix} ] \} ( {Y}_{1} ) ∈ \{ {e}_{1} , {e}_{2} , {e}_{3} , {e}_{4} \} and$$

$${W}_{2 , n} ∈ \{ \frac{1}{2} [ \begin{matrix}{Y}_{1} & {Y}_{2} \\ {Y}_{2} & - {Y}_{1}\end{matrix} ] , \frac{1}{2} [ \begin{matrix}{Y}_{1} & {Y}_{2} \\ - {Y}_{2} & {Y}_{1}\end{matrix} ] \} ( {Y}_{1} , {Y}_{2} ) ∈ \{ ( {e}_{1} , {e}_{2} ) , ( {e}_{4} , {e}_{1} ) \} and$$

$${W}_{2 , n} ∈ \{ \frac{1}{2} [ \begin{matrix}{Y}_{1} & {Y}_{2} \\ j {Y}_{1} & - j {Y}_{2}\end{matrix} ] , \frac{1}{2} [ \begin{matrix}{Y}_{1} & {Y}_{2} \\ - j {Y}_{1} & j {Y}_{2}\end{matrix} ] \} ( {Y}_{1} , {Y}_{2} ) ∈ \{ ( {e}_{1} , {e}_{2} ) , ( {e}_{1} , {e}_{4} ) \} and$$

Where Xₙ represents DFT vectors and Y₁, Y₂ are formed by beam selection vectors eₖ. The number of base beams is L=32 and neighboring beams in W₁ codeword are eight beams apart, t=8.

Exemplary statistics of the number of entries in the W₂ codebook portion per each beam in a W₁ codeword for the improved codebook described by the above equations using the indexing shown at FIG. 4 are then as follows:
Beam 1 in W₁
   4 (same beam per polarization) and
   4 (different beam per polarization) entries in the W₂ codebook portion.
Beam 2 in W₁
   4 (same beam per polarization) and
   2 (different beam per polarization) entries in the W₂ codebook portion.
Beam 3 in W₁
   0 entries in the W₂ codebook portion.
Beam 4 in W₁
   4 (same beam per polarization) and
   2 (different beam per polarization) entries in the W₂ codebook portion.

Note that the implementation immediately above represents an extreme case, where one beam (beam #3) has no entries at all. This could be understood as there being only 3 beams in the W₁ codeword. But more generally, any kind of codebook that has a non-equal number of entries in the narrow or sub-band/short-term W₂ codebook portion falls within these teachings.

As a more likely example for a 4-antenna implementation in which each W₁ codeword has beams is shown below.
Beam 1 in W₁
   4 (same beam per polarization) and
   2 (different beam per polarization) entries in the W₂ codebook portion.
Beam 2 in W₁
   4 (same beam per polarization) and
   1 (different beam per polarization) entries in the W₂ codebook portion.
Beam 3 in W₁
   2 entries in the W₂ codebook portion.
Beam 4 in W₁
   4 (same beam per polarization) and
   1 (different beam per polarization) entries in the W₂ codebook portion.

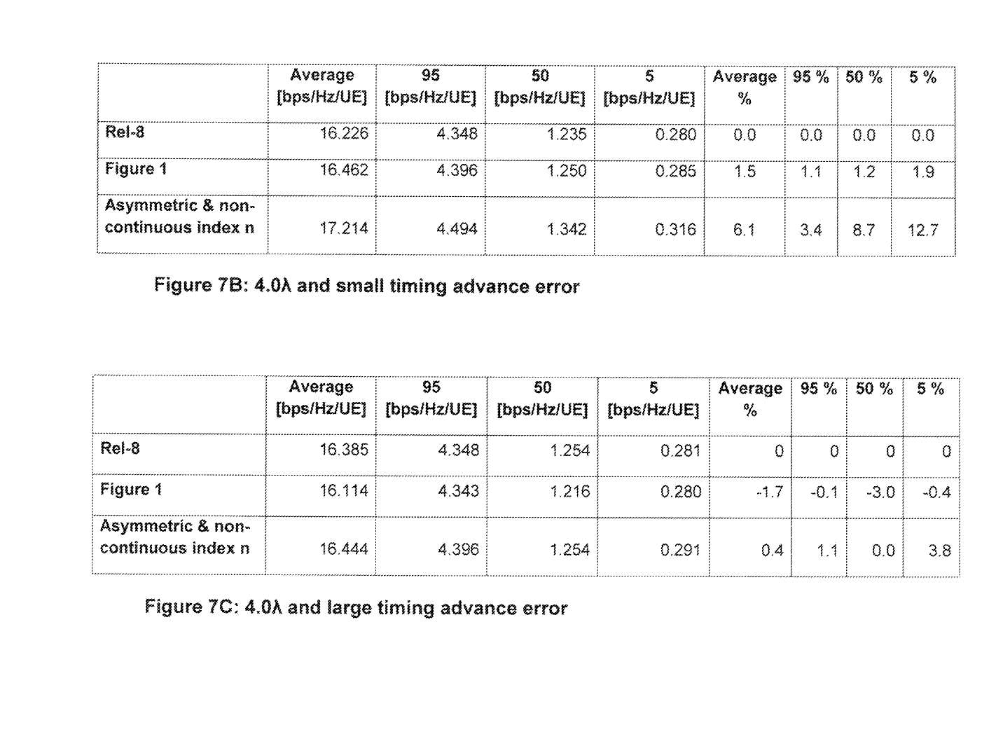

FIGS. 6A-C and 7A-C each have three rows reflecting throughput for a dual codebook according to UTRAN Release-8 (top row), according to FIG. 1 (center row), and according to FIG. 1 as modified above so that the W₂ codebook portion is asymmetric and also so that the indexing of codewords is not continuous.

These six figures demonstrate that the new codebook according to these teachings increases system average and coverage gain and is extremely robust to small as well as large timing advance errors as compared to the two other alternatives. Timing advance errors typically arise in multi-path communications from mis-calibration of the transmitting antenna array. FIGS. 6A-6C are for antenna spacing of 0.5λ (wavelength) while FIGS. 7A-C are for antenna spacing of 4). FIGS. 6A and 7A reflect no timing advance error; FIGS. 6B and 7B reflect a small timing advance error (maximum 12 nsec); and FIGS. 6C and 7C reflect a large timing advance error (maximum 65 nsec).

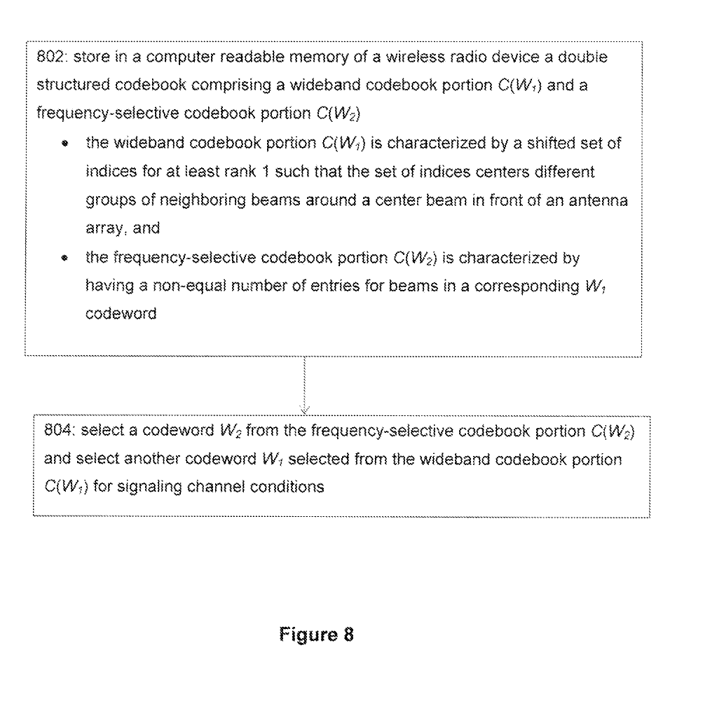

FIG. 8 presents a summary of the some of the above teachings for controlling a wireless radio device, such as a user equipment (UE) or a network access node to provide feedback about channel conditions. Such a UE can be implemented as a mobile phone, mobile terminal, cellular handset and the like, and the network access node can be implemented as an eNodeB, a NodeB, a base station, an access point AP, and the like.

Block 802 outlines that the wireless radio device stores in its local computer readable memory a double structured codebook comprising a wideband codebook portion C(W₁) and a frequency-selective codebook portion C(W₂). The wideband codebook portion C(W₁) is characterized by a shifted set of indices for at rank 1 such that the set of indices centers different groups of neighboring beams around a center beam in front of an antenna array. And the frequency-selective codebook portion C(W₂) is characterized by having a non-equal number of entries for beams in a corresponding W₁ codeword. Then at block 804 the device is controlled to use the stored double structured codebook to select a codeword W₂ from the frequency-selective codebook portion C(W₂), and to select another codeword W₁ from the wideband codebook portion C(W₁). The device may then construct a precoder W from those selected codewords W₂ and W₁, but regardless those selected codewords are for signaling conditions of a channel on which a wireless multi-path communication was received. Precoder construction from codewords selected from a double structured codebook is known in the art and is not further detailed herein.

While FIG. 8 and the examples above assume a double structured codebook, this also is not limiting to the broader teachings of the invention which can be utilized with other types of multi-structured codebooks that may have more than only two modules, such as for example a triple or quadruple or higher structured codebook which may be developed for future wireless systems and that utilize both shifted indexing as well as one (frequency selective) codebook portion having a non-equal number of entries for beams in a corresponding codeword from a different (wideband) codebook portion.

In one non-limiting embodiment the indices n defining Xₙ are shifted, to be centered around integer n_{c}, where n_{c} is an index defining a centering set of beams [−t 0 t] or their permutation. With reference to FIG. 4, Xₙ is 16 which is the total number of entries for rank 1, and n_{c} is 0 which is where to the set of indexes is shifted (in FIG. 4 the set of indexes for rank 1 is 24, 25 . . . 31, 0, 1, . . . 7). In prior art FIG. 5, indices run n=0, 1 . . . 15. In another example embodiment shown above at FIG. 4 for rank 1 the shifted set of indices for rank-1 are n=24, 25, 26, 27, 28, 29, 30, 31, 0, 1, 2, 3, 4, 5, 6, 7 This very specific example can be stated more generally that first the centering n_{c} index is found as the one with set of beams [−t 0 t], or its permutation. The other N/2−1 indices are found in the set <n_{c}−N/2, n_{c}+N/2−1>. Note that the last and first beams are wrap-around.

In one example shown above for a four-antenna, four rank solution there are four different groups of neighboring beams as follows:
Beam 1 in the wideband codebook portion C(W₁) with
   4 (same beam per polarization) and
   2 (different beam per polarization) entries in the frequency-selective codebook portion C(W₂):
Beam 2 in the wideband codebook portion C(W₁) with
   4 (same beam per polarization) and
   1 (different beam per polarization) entries in the frequency-selective codebook portion C(W₂);
Beam 3 in the wideband codebook portion C(W₁) with
   2 entries in the frequency-selective codebook portion C(W₂); and
Beam 4 in the wideband codebook portion C(W₁) with
   4 (same beam per polarization) and
   1 (different beam per polarization) entries in the frequency-selective codebook portion C(W₂).

This can be stated more generally in that for any given rank 1 beam in the wideband codebook portion C(W₁) there are:
multiple entries in the frequency-selective codebook portion C(W₂) having same beams per polarization; and
   at least one entry in the frequency-selective codebook portion C(W₂) having a different beam per polarization.

The logic diagram of FIG. 8, and the summary above from the perspective of the wireless radio device, may be considered to illustrate the operation of a method, and a result of execution of a computer program stored in a computer readable memory, and a specific manner in which components of an electronic device are configured to cause that electronic device to operate, whether such an electronic device is the UE, the access node/eNB, or one or more components thereof such as a modem, chipset, or the like. The various blocks shown in FIG. 8 or described in text above may also be considered as a plurality of coupled logic circuit elements constructed to carry out the associated function(s), or specific result of executing strings of computer program code or instructions stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a user equipment/mobile terminal or an access node/eNB, to perform the various functions summarized at FIG. 8 and above and (c) circuits, such as a microprocessor(s) or a portion of a microprocessor(s), that require software or firmware for operation, even if the software or firmware is not physically present. This definition of ‘circuitry’ applies to all uses of this term in this description, including in any claims. As a further example, as used in this description, the term “circuitry” would also cover an implementation of merely a processor (or multiple processors) or portion of a processor and its (or their) accompanying software and/or firmware. The term “circuitry” also covers, for example, a baseband integrated circuit or application specific integrated circuit for a UE or a similar integrated circuit in a network access node or other network device which operates according to these teachings.

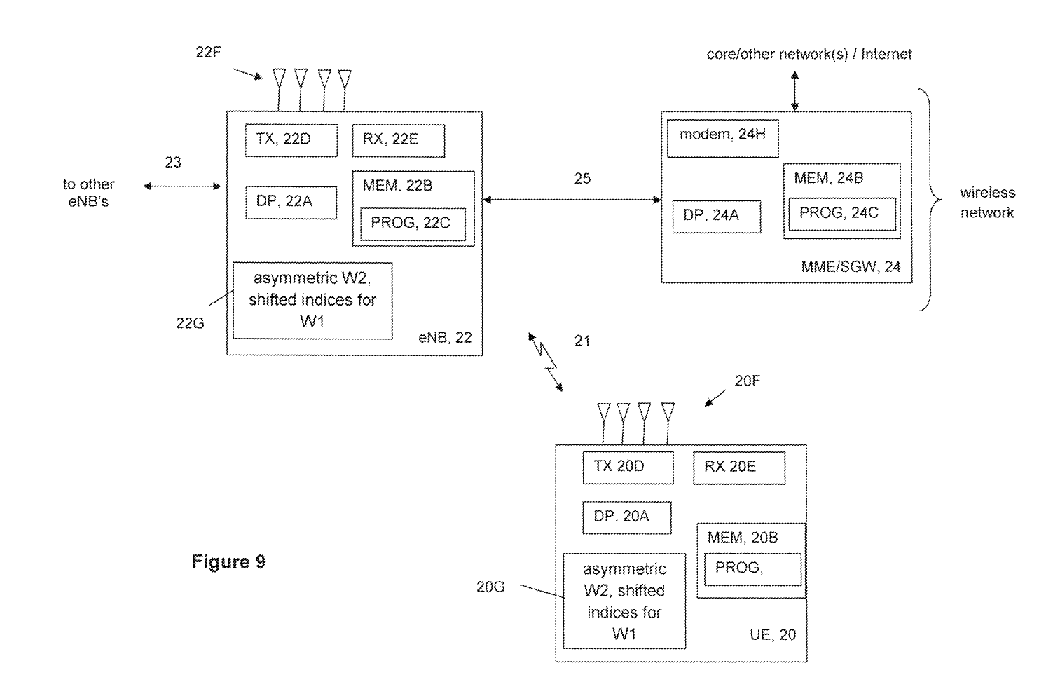

Reference is now made to FIG. 9 for illustrating a simplified block diagram of various electronic devices and apparatus that are suitable fir use in practicing the exemplary embodiments of this invention. In FIG. 9 an eNB 22 is adapted for communication over a wireless link 21 with an apparatus, such as a mobile terminal or other type of UE 20. The eNB 22 may be any access node (including frequency selective repeaters) of any wireless network, such as LTE, LTE-A, GSM, GERAN, WCDMA, WLAN and the like. The operator network of which the eNB 22 is a part may also include a network control element such as a mobility management entity MME and/or serving gateway SGW 24 or radio network controller RNC which provides connectivity with further networks (e.g. a publicly switched telephone network PSTN and/or a data communications network/Internet).

The UE 20 includes processing means such as at least one data processor (DP) 20A, storing means such as at least one computer-readable memory (MEM) 208 storing at least one computer program (PROG) 20C, communicating means such as a transmitter TX 20D and a receiver RX 20E for bidirectional wireless communications with the eNB 22 via one or more antennas 20F (an array of four antennas is shown per the above examples). Also stored in the MEM 20B at reference number 20G is the codebook portion C(W₁) with shifted indices and the asymmetric codebook portion C(W₁) as detailed in any of the various teachings above detailed above. Such a codebook may be implemented in the memory as an algorithm or look-up table for example without departing from these teachings.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F (an array of four antennas is shown). The eNB 22 stores at block 22G a similar codebook portion C(W₁) with shifted indices and an asymmetric codebook portion C(W₁) as detailed above.

While not particularly illustrated for the UE 20 or eNB 22, those devices are also assumed to include as part of their wireless communicating means a modem and/or a chipset which may or may not be inbuilt onto an RF front end chip within those devices 20, 22 and which also operates utilizing rules for the coarse and fine CQI measurement and reporting as set forth in detail above.

At least one of the PROGs 20C in the UE 20 is assumed to include a set of program instructions that, when executed by the associated DP 20A, enable the device to operate in accordance with the exemplary embodiments of this invention, as detailed above of which some are summarized at FIG. 8. The eNB 22 also has software stored in its MEM 22B to implement certain aspects of these teachings according to the above detailed embodiments. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire devices as depicted at FIG. 5 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular and other types of mobile telephones, mobile terminals, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like.

Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-Advanced systems, as noted above the exemplary embodiments of this invention are not limited for use with only this particular type of wireless communication system.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

What is claimed is:

1. A method for controlling a wireless radio device to provide feedback about channel conditions, the method comprising:
storing in a computer readable memory of the wireless radio device a multi-structured codebook comprising a wideband codebook portion C(W₁) and a frequency-selective codebook portion C(W₂), wherein the wideband codebook portion C(W₁) is characterized by a shifted set of indices for at least rank 1 such that the set of indices centers different groups of neighboring beams around a center beam in front of an antenna array, and wherein the frequency-selective codebook portion C(W₂) is characterized by having a non-equal number of entries fir beams in a corresponding W₁ codeword from the wideband codebook portion C(W₁); and
selecting a codeword W₂ from the frequency-selective codebook portion C(W₂) and selecting another codeword W₁ selected from the wideband codebook portion C(W₁) for signaling channel conditions.

2. The method according to claim 1, wherein indices n defining Xₙ are shifted, to be centered around integer n_{c}.

3. The method according to claim 2, wherein the integer n, is an index defining a centering set of beams [−t 0 t] or their permutation.

4. The method according to claim 1, wherein for a given rank 1 codeword W₁ in the wideband codebook portion C(W₁) there are:
multiple entries in the frequency-selective codebook portion C(W₂) having same beams per polarization; and
at least one entry in the frequency-selective codebook portion C(W₂) having a different beam per polarization.

5. The method according to claim 1, wherein a mobile terminal comprises the radio device.

6. An apparatus for controlling a wireless radio device to provide feedback about channel conditions, the apparatus comprising a processing system comprising at least one processor and a memory storing a set of computer instructions,
wherein the processing system is configured to cause the wireless radio device at least to:
store in the memory a multi-structured codebook comprising a wideband codebook portion C(W₁) and a frequency-selective codebook portion C(W₂), wherein the wideband codebook portion (W₁) is characterized by a shifted set of indices for at least rank 1 such that the set of indices centers diftferent groups of neighboring beams around a center beam in front of an antenna array, and wherein the frequency-selective codebook portion C(W₂) is characterized by having a non-equal number of entries for beams in a corresponding W₁ codeword from the wideband codebook portion C(W₁); and
selecting a codeword W₂ from the frequency-selective codebook portion C(W₂) and selecting another codeword W₁ selected from the wideband codebook portion C(W₁) for signaling channel conditions.

7. The apparatus according to claim 6, wherein indices n defining Xₙ are shifted, to be centered around integer n_{c}.

8. The apparatus according to claim 7, wherein the integer n_{c} is an index defining a centering set of beams [−t 0 t] or their permutation.

9. The apparatus according to claim 6, wherein for a given rank 1 codeword W₁ in the wideband codebook portion C(W₁) there are:
multiple entries in the frequency-selective codebook portion C(W₂) having same beams per polarization; and
at least one entry in the frequency-selective codebook portion C(W₂) having a different beam per polarization.

10. The apparatus according to claim 6, wherein a mobile terminal is the radio device and comprises the apparatus.

11. A computer readable memory tangibly storing a set of computer executable instructions for controlling a wireless radio device to provide feedback about channel conditions, in which the set of computer executable instructions comprises:
code for storing in a computer readable memory of the wireless radio device a multi-structured codebook comprising a wideband codebook portion C(W₁) and a frequency-selective codebook portion C(W₂), wherein the wideband codebook portion C(W) is characterized by a shifted set of indices for at least rank 1 such that the set of indices centers different groups of neighboring beams around a center beam in front of an antenna array, and wherein the frequency-selective codebook portion C(W₂) is characterized by having a non-equal number of entries for beams in a corresponding W₁ codeword from the wideband codebook portion C(W₁); and
code for selecting a codeword W₂ from the frequency-selective codebook portion (W₂) and selecting another codeword W₁ selected from the wideband codebook portion C(W₁) for signaling channel conditions.

12. The computer readable memory according to claim 11, wherein indices n defining Xₙ are shifted, to be centered around integer n_{c}.

13. The computer readable memory according to claim 12, wherein the integer n; is an index defining a centering set of beams [−t 0 t] or their permutation.

14. The computer readable memory according to claim 11, wherein for a given rank 1 codeword W₁ in the wideband codebook portion C(W₁) there are:
multiple entries in the frequency-selective codebook portion C(W₂) having same beams per polarization; and
at least one entry in the frequency-selective codebook portion C(W₂) having a different beam per polarization.

15. The computer readable memory according to claim 11, wherein a mobile terminal comprises the radio device.
